(19) United States
(12) Patent Application Publication
(10) Pub. No.: US 2014/0368475 A1
(43) Pub. Date: Dec. 18, 2014

(54) IN-VEHICLE MULTIMEDIA UNIT WITH INTERFACE FOR PORTABLE DEVICE

(71) Applicant: Ford Global Technologies, LLC, Dearborn, MI (US)

(72) Inventors: Robert SPAHL, Koeln (DE); Gareth CHENNELLS, South Hanningfield (GB)

(21) Appl. No.: 14/302,195

(22) Filed: Jun. 11, 2014

(30) Foreign Application Priority Data
Jun. 13, 2013 (DE) 10 2013 211 019.7

(51) Int. Cl. G06F 3/02; H04B 5/00

(52) U.S. Cl. CPC G06F 3/02; H04B 5/0025
USPC 345/184; 345/156

(57) ABSTRACT

An in-vehicle multimedia unit for a motor vehicle having an interface for a portable multimedia appliance (such as a smartphone, MP3 player or tablet PC), wherein all the multimedia functions and contents are provided solely by the portable appliance. Also a method for providing multimedia functions and content in a motor vehicle having an in-vehicle multimedia unit.

### CROSS-REFERENCE TO RELATED APPLICATIONS

This application claims foreign priority benefits under 35 U.S.C. §119(a)-(d) to DE 10 2013 211 019.7 filed Jun. 13, 2013, which is hereby incorporated by reference in its entirety.

### TECHNICAL FIELD

The invention relates to an in-vehicle multimedia unit for a motor vehicle having an interface for a portable multimedia appliance, and to a corresponding method.

### BACKGROUND

It is generally known that multimedia units in modern motor vehicles now usually comprise not only the conventional radio but also CD player functions, MP3 player functions, GPS or navigation options, queue query and indication and also telephone access or management and user control and a hands-free installation, weather services etc. The user control elements of such multimedia units in vehicles are usually becoming ever more complex and involved on account of the increasing wealth of functions. A large number of buttons, controls, switches and indicators and also displays are required for user control.

In addition, there is a desire for technically simplified and less expensive systems that allow the connection and incorporation of external MP3 players, mobile telephones, etc.

DE 10 2004 048 119 A1 discloses a communication apparatus for transmitting communication data within a vehicle, comprising a reception device for receiving an input signal and an output device for outputting a first output signal to an audio reproduction device on the basis of the input signal, wherein a sensor device can be used to detect a type for the input signal and wherein the output device can be used to output a second output signal to the audio reproduction device on the basis of the type of the input signal. The communication apparatus in the form of a motor vehicle hands-free installation allows the user to play back pieces of music coming from the mobile telephone on the radio of the vehicle, with the stereo quality of the music files being retained.

U.S. 2012/0172087 A1 discloses the practice of providing vehicles with two separate units for the multimedia equipment. One unit is permanently installed, but merely provides interfaces, amplifiers and codecs, whereas the other, mobile and retrofittable unit provides a processor, display, wireless communication means, GPS, etc. The mobile retrofittable unit is connected to the first unit, what is known as the service box, merely via a USB interface.

### SUMMARY

It is an object of the invention to provide simplified user control of a multimedia unit for a motor vehicle that is also technically simple and inexpensive.

The invention has recognized that modern portable multimedia appliances such as smartphones, MP3 players (iPod, etc.) or tablet PC (iPad, etc.) already entail and provide every conceivable function (MP3 player functions, radio streaming, GPS or navigation options, including queue indication, queue query and indication and also Internet, weather services, etc.) that would otherwise be provided by a multimedia unit that is permanently installed in the motor vehicle. Thus, the invention replaces the hitherto customary installed appliance with the portable multimedia appliance carried by a vehicle occupant and so already available. It is therefore also possible for user control to be carried out primarily or solely using the touch display of the portable multimedia appliance.

The invention also relates to a corresponding method for providing multimedia functions and contents in a motor vehicle having an in-vehicle multimedia unit, wherein all the multimedia functions and contents are provided solely by a portable multimedia appliance, and the in-vehicle multimedia unit is provided with an interface for the portable multimedia appliance for the purpose of connecting the latter.

The audio output of the multimedia content being played is produced using the motor vehicle loudspeakers. Inputs using a motor vehicle microphone or special buttons/keys on the steering wheel and possibly a push-to-talk key and/or the power supply can also still be provided by the vehicle. The vehicle provides only basic electronic interfaces to the loudspeakers and possibly microphone, etc., via the in-vehicle multimedia unit itself.

By contrast, the multimedia functions and contents are provided solely or just by the portable multimedia appliance, however.

In the present case, portable digital multimedia appliances such as smartphones, MP3 players or tablet PCs, which have the capability of storing and reproducing multimedia contents (particularly music and possibly navigation functions) and which are able to output these via an interface, are considered to be portable multimedia appliances. The appliances thus have user control elements, possibly a display, particularly a touch display, a memory and a processor, interfaces (e.g. USB, Bluetooth, WLAN) and sensors and also a radio part (mobile radio, 3G, LTE, etc.) and possibly further receivers (e.g. GPS receivers).

In particular, they are smartphones, that is to say mobile telephones that provide more computer functionality and connectivity than conventional advanced mobile telephones, which have the function of a transportable media player, a digital and video camera and a GPS navigation appliance, and are also equipped with a high-resolution touch-sensitive screen and have Internet capability.

In the present case, multimedia functions and contents are understood to mean not only the obvious playback of music but also both of stored and streamed music, navigation and map functions and contents, including queue information and also weather information and possibly telephone functions.

The concept extends to the in-vehicle multimedia unit using the display of the portable multimedia appliance, that is to say not comprising its own display in the vehicle or being permanently installed. In that case, a bracket or dock to hold the portable multimedia appliance may be provided at an appropriate location in the vehicle.

Alternatively, a display coupled to the output of the portable multimedia appliance may be provided, that is to say a non-smart display that is controlled via the portable multimedia appliance. In other words, the display is “unintelligent” and is used by the portable multimedia appliance as an output display. Hence, the dock (cf. above) can be dispensed with and a more standard interface provided on the dashboard.

If desired the in-vehicle multimedia unit may provide a single user control in the motor vehicle for controlling the music functions. It makes sense for the user control to be a rotary pushbutton. Preferably, it is used for volume adjustment (rotating the button) and muting (pushing the button).

The user control may also comprise illumination, the color of which can be altered, in particular, and which can thus indicate the status of the in-vehicle multimedia unit. The color can thus be used to indicate the coupling status (blue) and muting (red).

In addition, the standard keys and controls for telephone functions (cf. above) may be provided in the vehicle, but the “commands” for said telephone functions are passed to the portable multimedia appliance.

In one preferred embodiment of the invention, the coupling between in-vehicle multimedia unit and the portable multimedia appliance is initiated by means of NFC (Near Field Communication) interfaces. In other words, after the control has been touched with the portable multimedia appliance, NFC chips that are existent in the appliances trigger the communication by the in-vehicle multimedia unit with the portable multimedia appliance. This allows the portable multimedia appliance to be loaded with a control app (program) that automatically provides control of the in-vehicle multimedia unit or provides multimedia functions and contents for the vehicle, that is to say allows graphical user control of the multimedia functions for the motor vehicle.

The actual (data) connection to the portable multimedia appliance can be effected by means of wireless interfaces such as Bluetooth.

The in-vehicle multimedia unit thus provides some of the components of an audio system having an interface to the portable multimedia appliance, but without a radio receiver, user control elements and a display. The user is reliant on the portable multimedia appliance for control except that the rotary/push control described may be provided for volume control.

By touching the rotary/push control with the portable multimedia appliance, the connection can be initiated automatically when an NFC function is provided, which means that, by way of example, the control app is loaded onto the portable multimedia appliance and the coupling for data interchange is set up by means of USB, Bluetooth etc., otherwise standard manual coupling is no longer necessary.

The portable multimedia appliance thus may receive inputs from the user control for the volume functions, from a motor vehicle microphone, steering wheel keys and possible a push-to-talk key. The audio or voice output is output via the motor vehicle loudspeakers. The portable multimedia appliance may receive its power supply from the vehicle, and/or it may be provided with an antenna connection to the external vehicle antenna.

Further features and details of the invention can be found in the description below of the single figure, in which,

### BRIEF DESCRIPTION OF THE DRAWINGS

FIG. 1 is a schematic block diagram of an in-vehicle multimedia unit installed a motor vehicle with a connected portable multimedia appliance.

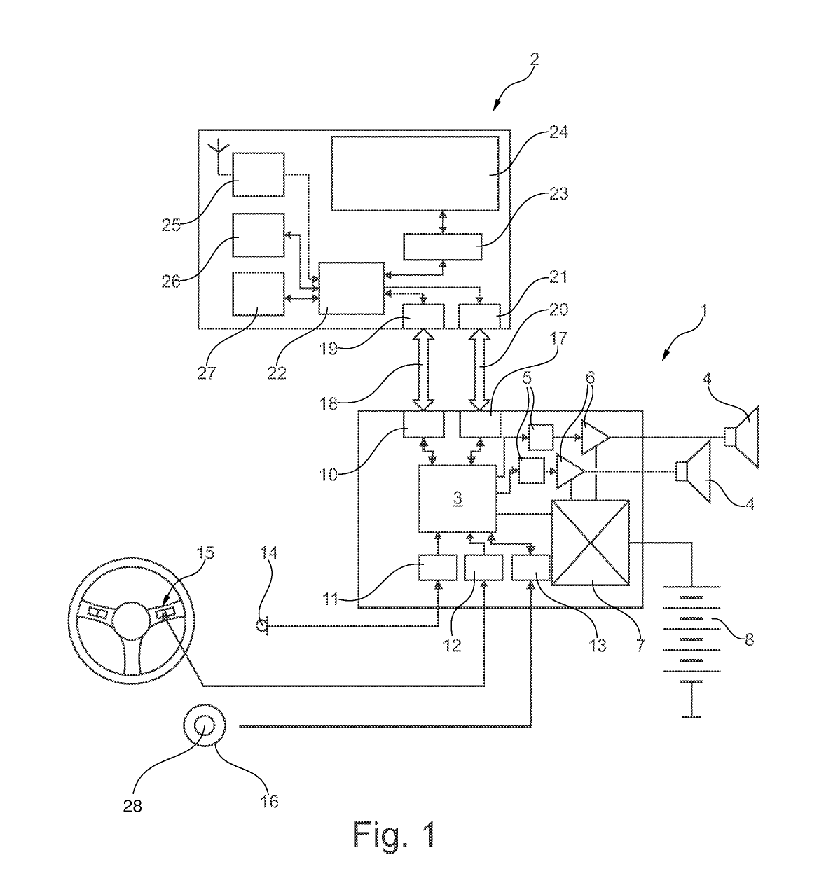

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The Figure shows an in-vehicle multimedia unit, denoted as a whole by 1. This is coupled to a portable multimedia appliance 2 that provides all the multimedia functions and contents on its own. The portable multimedia appliance 2 may, for example, be a smartphone, MP3 player, or tablet PC (personal computer).

The in-vehicle multimedia unit 1 is permanently installed in the motor vehicle and comprises a central interface hub 3 that provides a connection to loudspeakers 4 via appropriate interfaces 5 and amplifiers 6.

The in-vehicle multimedia unit 1 also comprises a power supply 7, which is connected to the onboard battery 8, for supplying power to the amplifiers 6 and uses the interface hub 3 to provide a power supply, e.g. for the USB interface 10, so that the latter can supply the portable appliance 2 with voltage 18 via the USB interface 19 of the portable appliance 2.

Furthermore, the in-vehicle multimedia unit 1 comprises interfaces 11, 12, 13, connected to the interface hub 3, for connection respectively to a microphone 14 installed in the motor vehicle, control buttons or keys 15 mounted on the steering wheel, and a volume control 16, which increases or decreases the volume when rotated and provides muting when pushed. These inputs are passed to the connected portable appliance 2 by the interface hub 3.

The volume control 16 may also comprise a Near Field Communication (NFC) module 28 for wireless communication with the relevant module in the portable appliance 2.

Furthermore, the in-vehicle multimedia unit 1 comprises a Bluetooth interface 17 that is connected to the interface hub 3 and that can set up a Bluetooth wireless link 20 to the portable appliance 2 via the Bluetooth module 21 of the latter for the purpose of data interchange and command interchange.

The portable appliance 2 includes a microprocessor having a memory 22 that is connected to the USB interface 19, to the Bluetooth module 21 and via a controller 23 to a touch display 24. In addition, the microprocessor 22 may be connected to a 3G mobile radio module 25, to a GPS module 26, and/or to an NFC module 27.

The coupling between in-vehicle multimedia unit 1 and the portable appliance 2 may be initiated by means of the NFC interfaces or modules 27, 28.

To this end, the portable appliance 2 is touched to the control 16. This contact triggers the communication by the in-vehicle multimedia unit 1 with the smartphone via the NFC chips that are existent in the appliances, as a result of which a control app (program) that automatically provides control of the in-vehicle multimedia unit 1 or provides the multimedia functions and contents for the vehicle from the smartphone 2, that is to say allows graphical user control of the multimedia functions for the motor vehicle, is loaded by the vehicle or from another source, e.g. the Internet, into the smartphone.

The actual (data) connection between smartphone 2 and in-vehicle multimedia unit 1 is made by means of wireless Bluetooth 20 via the modules 17 and 21. Otherwise standard manual coupling, including PIN input, etc., is no longer necessary.

The USB connection 18 may therefore by used only for the supply of power to the portable device 2 from the vehicle electrical system.

The in-vehicle multimedia unit 1 is thus essentially an audio system having an interface 10, 17 to the portable multimedia appliance, but without a radio function, user control elements and a display.

The smartphone 2 thus provides all the MP3 player, radio streaming, GPS and navigation options, including queue indication, queue query and indication and also Internet services, weather services functions. The user control can therefore also be carried out using the existent touch display 24.

The audio output of the multimedia contents is produced using the motor vehicle loudspeakers 4. Operator control input to the multimedia unit 1 may be made using a microphone 14 and/or the buttons/keys 15 on the steering wheel.

The in-vehicle multimedia unit 1 also uses the display 24 of the smartphone for indication purposes; thus, there is no requirement for a dedicated multimedia display to be permanently installed in the vehicle.

The user control 16 may also comprise illumination, the color of which may change to indicate the status of the in-vehicle multimedia unit 1. For example, the color of the illumination of user control 16 may be blue to indicate the coupling status and red to indicate that the audio volume is muted.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An in-vehicle multimedia unit for a motor vehicle comprising an interface for a portable multimedia appliance, wherein all multimedia functions and contents are provided solely by the portable multimedia appliance.

2. The in-vehicle multimedia unit of claim 1, comprising interfaces for output, input and/or power supply.

3. The in-vehicle multimedia unit of claim 1, wherein the in-vehicle multimedia uses the display of the portable multimedia appliance.

4. The in-vehicle multimedia unit of claim 1, wherein a single user control is provided in the motor vehicle.

5. The in-vehicle multimedia unit of claim 4, wherein the user control is a rotary pushbutton.

6. The in-vehicle multimedia unit of claim 4, wherein the user control comprises illumination, the color of which can be altered.

7. The in-vehicle multimedia unit of claim 1, wherein communication with the portable multimedia appliance is initiated by means of a near field communication interface.

8. The in-vehicle multimedia unit of claim 1, wherein communication with the portable multimedia appliance is by means of a wireless interface.

9. A method for providing multimedia functions and contents in a motor vehicle having a in-vehicle multimedia unit, particularly a in-vehicle multimedia unit of one of the preceding claims, wherein all the multimedia functions and contents are provided solely by a portable multimedia appliance, and the in-vehicle multimedia unit is provided with an interface for the portable multimedia appliance for the purpose of connecting the latter.

10. The method of claim 9, wherein the in-vehicle multimedia unit in the motor vehicle merely has interfaces for output, input and/or power supply for the connected portable multimedia appliance.

11. The method of claim 9, wherein the coupling of the in-vehicle multimedia unit to the portable multimedia appliance is initiated by means of near field communication interfaces.
